(19) United States
(12) Patent Application Publication
(10) Pub. No.: US 2011/0201742 A1
(43) Pub. Date: Aug. 18, 2011

(54) Halogenated Elastomers with Heat Activated Latent Curative

(76) Inventors: J. Scott Parent, Kingston (CA); Ralph A. Whitney, Kingston (CA)

(21) Appl. No.: 13/016,388

(22) Filed: Jan. 28, 2011

Related U.S. Application Data
(60) Provisional application No. 61/299,434, filed on Jan. 29, 2010.

(51) Int. Cl. C08F 8/30; C08F 236/08; C08F 212/12; C08L 9/00; C08L 25/16; C08K 3/34

(52) U.S. Cl. 524/445; 525/332.3; 525/333.4; 524/572; 524/576; 525/374

(57) ABSTRACT

Mixtures of halogenated elastomers and latent curatives are provided that cure when subjected to sufficient heat to decompose the latent curative. Decomposition products include CO₂ and N-nucleophiles, which participate in nucleophilic substitution reactions leading to crosslinking of the elastomers. Transparent thermoset products that were free of voids were produced.

### RELATED APPLICATIONS

This application claims the benefit of the filing date of U.S. Provisional Patent Application No. 61/299,434, filed on Jan. 29, 2010, the contents of which are incorporated herein by reference in their entirety.

### FIELD OF THE INVENTION

The present invention relates to a method of curing halogenated isobutylene-rich elastomers.

### BACKGROUND OF THE INVENTION

Poly(isobutylene-co-isoprene) (“IIR”) is a synthetic elastomer commonly known as butyl rubber that has been prepared since the 1940's through random cationic copolymerization of isobutylene with small amounts of isoprene (1-2 mole %). Halogenated forms of IIR, which include brominated IIR (“BIIR”) and chlorinated IIR (“CIIR”) cure (or crosslink) more rapidly than unhalogenated forms when treated with standard vulcanization techniques. Similarly, brominated poly(isobutylene-co-methylstyrene) (“BIMS”) is an elastomeric material that, when cured, has good air impermeability and oxidative resistance qualities. The increased reactivity of halogenated IIR is due to the presence of allylic halide functionality, which is susceptible to nucleophilic substitution. Increased reactivity of BIMS is due to the presence of benzylic halide functionality, which is susceptible to nucleophilic substitution. BIMS and BIIR can be cured with sulfur and Lewis acid formulations.

As a result of its molecular structure, IIR possesses superior gas impermeability, excellent thermal stability, good resistance to ozone oxidation, exceptional dampening characteristics, and extended fatigue resistance. In many applications, such elastomers are cross-linked to generate thermoset (cured) articles with greatly improved modulus, creep resistance and tensile properties. Vulcanizing systems usually include sulfur, quinoids, resins, sulfur donors and/or low-sulfur, high-performance vulcanization accelerators. Alternatively, IIR can be halogenated prior to crosslinking to augment its reactivity toward sulfur nucleophiles and toward Lewis acids.

An alternate approach for cross-linking halogenated elastomers involves repeated N-alkylation of primary amines, as illustrated in FIG. 1 (Parent, J. S. et al. Macromolecules 35, 3374-3379, 2002). Given the wide array of available primary amines, this technology can yield thermosets that contain additional chemical reactivity. For example, a cure system with pendant groups such as (MeO)₃SiCH₂CH₂CH₂NH₂ may be useful for elastomeric composites (e.g., BIIR, BIMS). The amine end of (MeO)₃SiCH₂CH₂CH₂NH₂ is available for nucleophilic displacement reactions, and thus becomes bound to the allylic or benzylic carbons while the silicon end of (MeO)₃SiCH₂CH₂CH₂NH₂ is available for binding to silica; for example, advantageously it may bind to Si of siliceous fillers. However, amine alkylation occurs quickly at temperatures that develop during rubber compounding and so there are scorch concerns with elastomers bearing amine pendant groups. Therefore, the practicality of this chemistry would be improved by techniques for controlled (i.e., delayed or selected timing) nucleophile delivery. Thus there is a need for such techniques to control onset of crosslinking halogenated elastomers; therefore, the need exists for latent forms of primary amine nucleophiles that are easily handled, and can be activated when desired.

### SUMMARY OF THE INVENTION

In a first aspect the invention provides a curable elastomeric mixture comprising (i) a halogenated elastomer; and (ii) a latent curative, which comprises a CO₂ moiety and a N-nucleophile moiety, wherein the mixture remains uncured until it is subjected to a trigger.

In a second aspect, the invention provides a cured polymeric product prepared by subjecting to a trigger the mixture of the curable elastomeric mixture of the first aspect.

In a third aspect, the invention provides a process for preparing a crosslinkable elastomeric mixture, comprising mixing a halogenated elastomer with a latent curative at a temperature below that which supports decomposition of the latent curative, forming an elastomeric mixture that remains uncured until it is subjected to a trigger, wherein the latent curative comprises a CO₂ moiety and a N-nucleophile moiety.

In a fourth aspect, the invention provides a process for preparing crosslinked polymer, comprising mixing a halogenated elastomer with a latent curative at a temperature below that which supports decomposition of the latent curative; and subjecting the mixture to a trigger, wherein the latent curative comprises a CO₂ moiety and a N-nucleophile moiety.

In a fifth aspect, the invention provides a kit comprising halogenated elastomer, latent curative, and instructions comprising directions to subject a mixture of the halogenated elastomer and the latent curative to sufficient heat to release CO₂ from the latent curative to form a cross-linked polymer.

In a sixth aspect, the invention provides a kit comprising a first container housing halogenated elastomer, a second container housing latent curative, and instructions for use of the kit comprising directions to mix the halogenated elastomer and the latent curative together and heat sufficiently to release CO₂ from the latent curative to form a cross-linked polymer.

In embodiments of the first to fourth aspects of the invention, the trigger is sufficient heat to release CO₂ from the latent curative. In embodiments of the first to sixth aspects of the invention, the latent curative comprises a CO₂-derived salt of ammonia. In certain embodiments of the first to sixth aspects of the invention, the latent curative is ammonium bicarbonate, ammonium carbamate, or ammonium carbonate. In some embodiments of the first to sixth aspects of the invention, the latent curative comprises a CO₂-derived salt of a primary amine, a CO₂-derived salt of an imine, a CO₂-derived salt of an amidine, a CO₂-derived salt of a guanidine, or a carbamate ester.

In embodiments of the first to sixth aspects of the invention, the latent curative is (n-C₁₆H₃₃NH₃)ₙ—C₁₆H₃₃NHCO₂, ((MeO)₃SiCH₂CH₂CH₂NH₃)(MeO)₃SiCH₂CH₂CH₂NHCO₂, or a bicarbonate salt of protonated DBU.

In embodiments of the first to sixth aspects of the invention, the latent curative is substituted, wherein a substituent is silane, alkoxysilane, siloxane, alcohol, epoxide, ether, carbonyl, carboxylic acid, carboxylate, aldehyde, ester, anhydride, carbonate, amine, amide, carbamate, urea, maleimide, nitrite, cyano, olefin, alkenyl, alkynyl, borane, borate, thiol, thioether, sulfate, sulfonate, sulfite, thioester, dithioester, halogen, peroxide, phosphate, phosphonate, phosphine, phosphate, alkyl, or aryl. In embodiments of the first to sixth aspects of the invention, the halogenated elastomer comprises allylic halide functionality; benzylic halide functionality; alkyl halide functionality; or a combination thereof. Embodiments of the first to sixth aspects of the invention, further comprise a filler, where the filler comprises carbon black, precipitated silica, clay, glass fibre, polymeric fibre, finely divided minerals, exfoliated clay platelets, sub-micron particles of carbon black, or sub-micron particles of silica. In embodiments of the first to sixth aspects of the invention, the halogenated elastomer comprises brominated butyl rubber (BIIR), chlorinated butyl rubber (CIIR), brominated poly(isobutylene-co-methylstyrene) (BIMS), or polychloroprene. In embodiments of the above aspects the mixture further comprises water, a moisture-generating component, or a hydrolysis catalyst. In such embodiments the moisture-generating component comprises CaSO₄.2H₂O (gypsum), MgSO₄.7H₂O, or a combination thereof. In other such embodiments the hydrolysis catalyst comprises a carboxylic acid, sulfonic acid, organotitanate, an organometallic compound including carboxylate of lead, cobalt, iron, nickel, zinc and tin, or any combination of the above.

In embodiments of the fifth and sixth aspects, a kit further comprises a molded container suitable for use when curing. In embodiments of the fifth and sixth aspects, the instructions comprise printed material, text or symbols provided on an electronic-readable medium, directions to an internet web site, or electronic mail.

### BRIEF DESCRIPTION OF THE DRAWINGS

For a better understanding of the invention and to show more clearly how it may be carried into effect, reference will now be made by way of example to the accompanying drawings, which illustrate aspects and features according to embodiments of the present invention, and in which:

FIG. 1 is a schematic showing a synthetic methodology to prepare thermoset derivatives of BIIR by N-alkylation of ammonia and primary amines.

FIG. 2 is a schematic showing a synthetic methodology used to prepare thermoset derivatives of BIIR by N-alkylation of DBU.

FIG. 3 graphically presents evolution of storage modulus of mixtures of BIIR and (NH₄)₂CO₃.

FIG. 4 graphically presents evolution of storage modulus of mixtures of BIIR with (NH₄)₂CO₃, BIIR with (NH₄)HCO₃, and BIIR with (NH₄)NH₂CO₂.

FIG. 5 graphically presents evolution of storage modulus of mixtures of BIIR with 1.3 eq. C₁₆H₃₃NH₂, and BIIR with 0.65 eq. (R¹NH₃)R¹NHCO₂ at 75° C. and 100° C. as indicated, where R¹ is C₁₆H₃₃.

FIG. 6 graphically presents evolution of storage modulus of mixtures of BIIR with 1.3 eq. C₁₆H₃₃NH₂ (◯); BIIR with 1.3 eq. (R¹NH₃)R¹NHCO₂ (); and BIIR with 1.3 eq. R¹NHCO₂-t-Bu (⋄), where R¹ is C₁₆H₃₃.

FIG. 7 graphically presents evolution of storage modulus of mixtures of BIIR with 1.3 eq. DBUH.HCO₃ (); BIIR with 1.3 eq. DBUH.HCO₃ and 1.3 eq. CaSO₄.2H₂O; BIIR with 1.3 eq. DBU (▴); and BIIR with 1.3 eq. DBU and 1.3 eq. CaSO₄.2H₂O (Δ).

FIG. 8 graphically presents evolution of storage modulus of a mixture of BIMS with 1.3 eq. R¹NHCO₂-t-Bu.

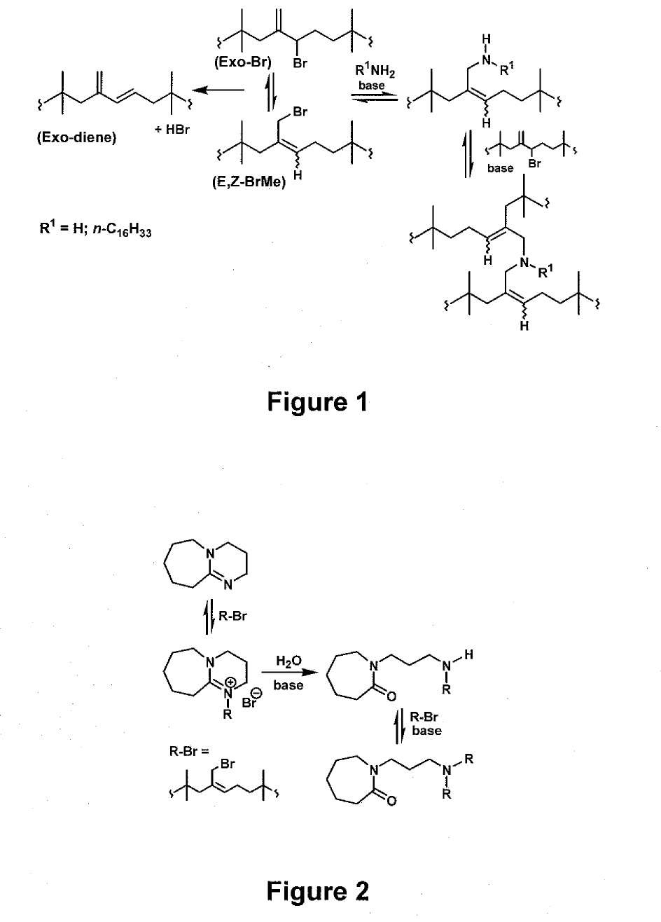

### DETAILED DESCRIPTION OF THE INVENTION

The present invention includes a method of crosslinking halogenated elastomers. Aspects of the present invention include products that are stable uncured mixtures of halogenated elastomers and latent curatives, that will not cure until triggered to do so (e.g., heated). Other aspects of the present invention include cured products prepared from mixtures of halogenated elastomers and latent curatives. Methods of preparing such uncured mixtures and methods of curing such products are also described in detail below. Briefly, a trigger includes heating at a sufficient temperature to decompose the latent curactive. Decomposition products include CO₂ and N-nucleophiles. In some embodiments, initial N-nucleophile decomposition products undergo hydrolysis to form more reactive N-nucleophiles. Crosslinks form as a result of nucleophilic substitution reactions between halogenated elastomers and N-nucleophiles and thermoset (cured) derivatives are produced. Examples are provided wherein samples are easily mixed at conventional compounding temperatures, but cure rapidly at conventional cure temperatures. The following terms will be used in the description of these aspects.

### DEFINITIONS

As used herein, the term “latent curative” is a compound that has the potential to initiate crosslinking of certain elastomers but which does not do so unless activated by a trigger.

As used herein, the term “IIR” means poly(isobutylene-co-isoprene), which is a synthetic elastomer commonly known as butyl rubber. As used herein, the term “BIIR” means brominated butyl rubber. As used herein, the term “CIIR” means chlorinated butyl rubber.

As used herein, the term “BIMS” means brominated poly(isobutylene-co-methylstyrene).

As used herein, the term “halogenated elastomer” means a polymer, which includes a halogen, that is reactive toward nitrogen nucleophiles.

As used herein, the terms “curing”, “vulcanizing”, and “cross-linking” are used interchangeably and refer to formation of covalent bonds that link one polymer chain to another thereby altering the physical properties of the material.

As used herein, the term “nucleophilic substitution” refers to displacement of a halide by a nucleophilic reagent and includes N-alkylation of imines, amines and the like.

As used herein, the term “moisture-generating component” is a compound that releases water upon heating and, although the released water participates in reactions, the remainder of the moisture-generating component is either non-reactive or does not inhibit reactions that lead to crosslinks between polymers.

A “trigger” is a change of conditions (e.g., introduction of water, change in temperature) that causes a chemical reaction or a series of chemical reactions.

As used herein “substituted” refers to a structure having one or more substituents. A substituent is an atom or group of bonded atoms that can be considered to have replaced one or more hydrogen atoms attached to a parent molecular entity. For the purpose of the present invention, such atom or group should not inhibit a desired reaction. A substituent can be further substituted. In preferred embodiments, substituents are selected to perform a function.

As used herein, the term “functionality” is a chemical moiety that is not nucleophilic and does not react with allylic carbon or benzyllic carbon, but rather performs a function. For example, a pendant group on an elastomer that includes a Si moiety performs the function of binding to silaceous fillers. Non-limiting examples of functionalities include: silane, alkoxysilane, siloxane, alcohol, epoxide, ether, carbonyl, carboxylic acid, carboxylate, aldehyde, ester, anhydride, carbonate, amine, amide, carbamate, urea, maleimide, nitrile, cyano, olefin, alkynyl, alkenyl, borane, borate, thiol, thioether, sulfate, sulfonate, sulfite, thioester, dithioester, halogen, peroxide, phosphate, phosphonate, phosphine, phosphate, alkyl, and aryl.

As used herein the term “N-nucleophile” refers to a compound comprising a nitrogen bearing a lone pair of electrons that undergoes a nucleophilic substitution reaction at an electrophilic site. This may occur, for example, at an allylic or benzyllic site of a halogenated elastomer.

As used herein the term “a CO₂-derived salt” means an ionic compound that upon being heated to a sufficiently high temperature releases CO₂ and a N-nucleophile. In some embodiments described herein, an initial decomposition product N-nucleophile undergoes hydrolysis to form a more reactive N-nucleophile.

### Description

As discussed above, using previously known technology, it was not possible to adequately control the rate at which halogenated elastomers were cured when they were in the presence of an N-nucleophile (e.g., amine). This lack of control leads to scorch problems.

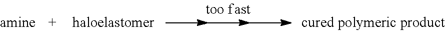

Surprisingly, it has been discovered that control of the cure rate of halogenated elastomers is attained by replacing the N-nucleophile with a latent curative. A latent curative is a compound that has the potential to initiate crosslinking of elastomers but which does not do so unless activated by a trigger. For purposes of the present invention, the trigger is sufficient heat to decompose the latent curative and form decomposition products that include CO₂ and a N-nucleophile. Thus, by replacing the N-nucleophile (e.g., amine) with a latent curative (e.g., a N-nucleophile precursor) curing is delayed. In addition, for certain N-nucleophiles (i.e., decomposition products of certain latent curatives) the cure rate is advantageously slowed. As described herein, an example of a latent curative is a salt that comprises CO₂ together with N-nucleophiles such as derivatives of ammonia, primary amines, imines, amidines, guanidines, which are effective curatives of halogenated elastomers. Thus, controlled curing of a halogenated elastomer is attained by controlled decomposition of a latent curative to produce one or more N-nucleophilic decomposition products that crosslink the elastomer by nucleophilic substitution reactions.

### Halogenated Elastomer

“Halogenated elastomer” as used herein includes mers that are unreactive with the latent curative described herein, and halogen-comprising electrophiles that are also unreactive with the latent curative, but that react with nitrogen nucleophiles. The unreactive mer composition within a halogenated elastomer is not particularly restricted, and may comprise any polymerized olefin monomer. As used herein, the term “olefin monomer” is intended to have a broad meaning and encompasses α-olefin monomers, diolefin monomers and polymerizable monomers comprising at least one olefin linkage.

In certain embodiments, the olefin monomer is an α-olefin monomer. α-Olefin monomers are well known in the art and the choice thereof for use in the present process is within the purview of a person skilled in the art. Preferably, α-olefin monomers of the invention include isobutylene, ethylene, propylene, 1-butene, 1-pentene, 1-hexene, 1-octene, and branched isomers thereof. Other preferred α-olefin monomers of the invention include styrene, α-methylstyrene, para-methylstyrene, and combinations thereof. Particularly preferred α-olefin monomers include isobutylene and para-methylstyrene.

In other embodiments, the olefin monomer comprises a diolefin monomer. Diolefin monomers are well known in the art and the choice thereof for use in the present process is within the purview of a person skilled in the art. Non limiting examples of suitable diolefin monomers include: 1,3-butadiene; isoprene; divinyl benzene; 2-chloro-1,3-butadiene; 2,3-dimethyl-1,3-butadiene; 2-ethyl-1,3-butadiene; piperylene; myrcene; allene; 1,2-butadiene; 1,4,9-decatriene; 1,4-hexadiene; 1,6-octadiene; 1,5-hexadiene; 4-methyl-1,4-hexadiene; 5-methyl-1,4-hexadiene; 7-methyl-1,6-octadiene; phenylbutadiene; pentadiene; and combinations thereof. In another embodiment, the diolefin monomer is an alicyclic compound. Non-limiting examples of suitable alicyclic compounds include: norbornadiene and alkyl derivatives thereof; 5-alkylidene-2-norbornene; 5-alkenyl-2-norbornene; 5-methylene-2-norbornene; 5-ethylidene-2-norbornene; 5-propenyl-2-norbornene; 1,4-cyclohexadiene; 1,5-cyclooctadiene; 1,5-cyclododecadiene; methyltetrahydroindene; dicyclopentadiene; bicyclo[2.2.1]hepta-2,5-diene; and combinations thereof. Preferred diolefin monomers include isoprene and 2-chloro-1,3-butadiene. Of course it is possible to utilize mixtures of the various types of olefin monomers described hereinabove.

In an embodiment, the olefin is a mixture of isobutylene and at least one diolefin monomer. A preferred such monomer mixture comprises isobutylene and isoprene. In this embodiment, it is preferred to incorporate into the preferred mixture of isobutylene and isoprene from about 0.5 to about 3, more preferably from about 1 to about 2 mole percent of the diolefin monomer.

In an embodiment, the olefin is a mixture of isobutylene and at least one α-olefin. A preferred such monomer mixture comprises isobutylene and para-methylstyrene. In this embodiment, it is preferred to incorporate into the mixture of isobutylene and para-methylstyrene from about 0.5 to about 3, more preferably from about 1 to about 2 mole percent of the α-olefin monomer.

As one of skill in the art of the invention will recognize, the number of halogen-containing electrophilic groups per polymer chain will affect the extent of cross-linking that can be achieved by reaction with a triggered latent curative. Typically, the electrophile content of a halogenated elastomer is from about 0.1 to about 100 groups per 1000 polymer backbone carbons. In some cases, electrophile content is between 5 and 50 groups per 1000 polymer backbone carbons.

Selection of a halogenated electrophile is within the purview of a person skilled in the art, and can be made from a group consisting of alkyl halide, allylic halide and benzylic halide, and combinations thereof. Non-limiting, generic structures for these examples are illustrated below, where X represents a halo group and R¹-R⁵ are aliphatic.

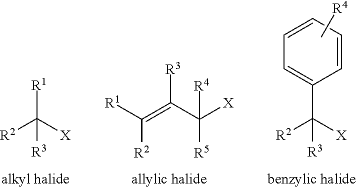

In another embodiment, a halogenated elastomer is comprised of a random distribution of isobutylene mers, isoprene mers and allylic halide electrophiles

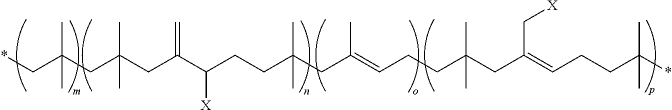

where X is a halo group where preferred halogens include bromine and chlorine, and combinations thereof. Elastomers comprised of about 97 mole % isobutylene, 1 mole % isoprene, and 2 mole % allylic halide are commonly known as halogenated butyl rubber.

In a preferred embodiment, the halogenated elastomer is comprised of a random distribution of isobutylene mers, para-methylstyrene mers and a benzylic halide electrophile

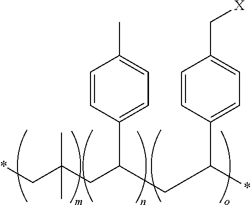

where X is a halo group where preferred halogens include bromine and chlorine, and combinations thereof. Elastomers comprised of about 97 mole % isobutylene, 1 mole % para-methylstyrene, and 2 mole % benzylic bromide are commonly known as BIMS.

In an embodiment, the halogenated elastomer is comprised of a random distribution of 2-chloro-1,3-butadiene mars and an allylic halide electrophile.

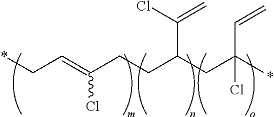

This elastomer is commonly known as polychloroprene.

Preferably the halogenated elastomers used in the present invention have a molecular weight (Mn) in the range from about 10,000 to about 500,000, more preferably from about 10,000 to about 200,000, even more preferably from about 20,000 to about 100,000. It will be understood by those of skill in the art that reference to molecular weight refers to a population of polymer molecules and not necessarily to a single or particular polymer molecule.

### Latent Curatives

In certain embodiments of the invention, the latent curative comprises CO₂-derived salts that upon heating (Δ) decompose to form ammonia and CO₂ (see below).

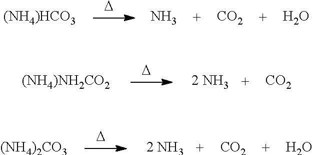

Non-limiting examples of this embodiment include ammonium bicarbonate, ammonium carbamate, and ammonium carbonate.

In an embodiment of the invention, the latent curative comprises CO₂-derived salts that upon heating decompose to form a primary amine and CO₂ (see below).

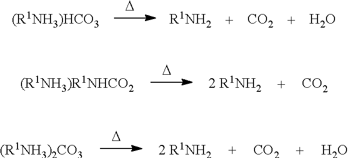

where R¹ is a substituted or unsubstituted C₁ to about C₂₅ alkyl, or a substituted or unsubstituted C₁ to about C₁₂ aryl group, wherein substituents may bear a functionality. Non-limiting examples of this embodiment include (n-C₁₆H₃₃NH₃)ₙ—C₁₆H₃₃NHCO₂ and ((MeO)₃SiCH₂CH₂CH₂NH₃) (MeO)₃SiCH₂CH₂CH₂NHCO₂.

In an embodiment of the invention, the latent curative comprises CO₂-derived salts that upon heating decompose to form an imine and CO₂ (see below).

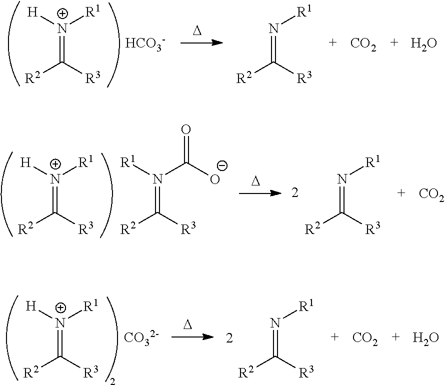

where R¹ is a substituted or unsubstituted C₁ to about C₂₅ alkyl, or a substituted or unsubstituted C₁ to about C₁₂ aryl group, wherein substituents may bear a functionality;

R² and R³ are independently H, substituted or unsubstituted C₁ to about C₂₅ alkyl, or a substituted or unsubstituted C₁ to about C₁₂ aryl group, wherein substituents may bear a functionality; and

R¹ and R³ can be independent or can be taken together with the C═N unit to which they are attached, to form a cyclic structure. In some embodiments, the cyclic structure is non-aromatic.

Once the latent curative of this embodiment decomposes into CO₂, imine and water, imine is available to act as an N-nucleophile and to participate in nucleophilic displacement reactions with the haloelastomer to form crosslinks. However, with water present, imine may undergo hydrolysis to form an amine (a more reactive N-nucleophile) which rapidly leads to crosslinking of the halogenated elastomers via nucleophilic displacement reactions. In this way, after certain latent curatives are subjected to a trigger, the presence of moisture (water) in the mixture supports crosslinking. Methods of incorporating water into the mixture are described below.

In an embodiment of the invention, the latent curative comprises CO₂-derived salts that upon heating decompose to form an amidine and CO₂ (see below).

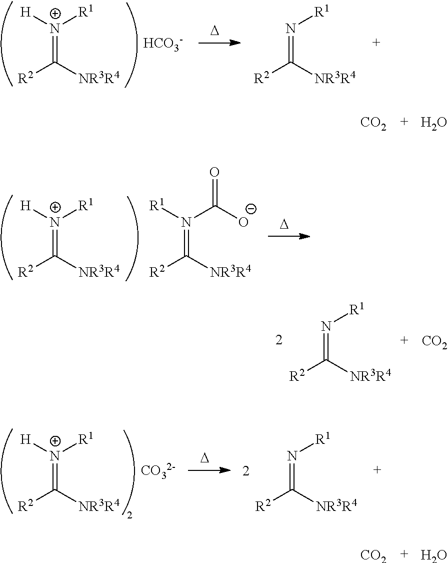

wherein R¹ is a substituted or unsubstituted C₁ to about C₂₅ alkyl, or a substituted or unsubstituted C₁ to about C₁₂ aryl group, wherein substituents may bear a functionality;

R², R³ and R⁴ are independently H, substituted or unsubstituted C₁ to about C₂₅ alkyl, or a substituted or unsubstituted C₁ to about C₁₂ aryl group, wherein substituents may bear a functionality; and

one or more combinations of two of R¹ to R⁴, such as R¹ and R³ can be independent or taken together with the N—C═N or C—C—N unit to which they are attached, can form a cyclic structure. In some embodiments, the cyclic structure is non-aromatic. A non-limiting example of this embodiment includes the bicarbonate salt of protonated DBU, as illustrated below.

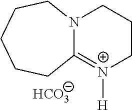

In an embodiment of the invention, the latent curative comprises CO₂-derived salts that upon heating decompose to form a guanidine and CO₂ (see below).

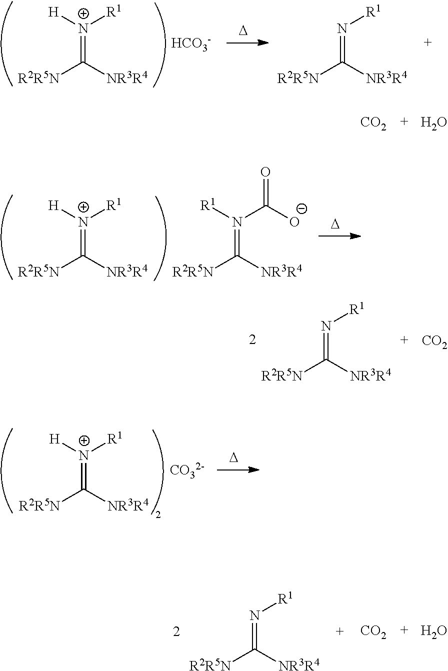

wherein R¹ is a substituted or unsubstituted C₁ to about C₂₅ alkyl, or a substituted or unsubstituted C₁ to about C₁₂ aryl group, wherein substituents may bear a functionality;

R², R³, R⁴ and R⁵ are independently H, substituted or unsubstituted C₁ to about C₂₅ alkyl, or a substituted or unsubstituted C₁ to about C₁₂ aryl group, wherein substituents may bear a functionality; and

one or more combinations of two of R¹ to R⁵, such as R¹ and R³ can be independent or taken together with the N—C═N or N—C—N unit to which they are attached, can form a cyclic structure. In some embodiments, the cyclic structure is non-aromatic.

In an embodiment of the invention, the latent curative comprises CO₂-derived salts that upon heating decompose to form a carbamate ester and CO₂ (see below).

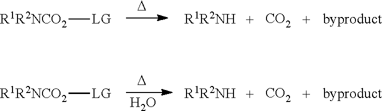

wherein LG, which represents a leaving group, is selected from functionalities that are well known to those skilful in the art, and may include alkyl, halide, carboxylate, trialkylsilyl and the like; and

R¹ and R² are independently H, substituted or unsubstituted C₁ to about C₂₅ alkyl, or a substituted or unsubstituted C₁ to about C₁₂ aryl group, wherein substituents may bear a functionality; and

R¹ and R² can be independent or can be taken together with the N to which they are attached, to form a cyclic structure. In some embodiments, the cyclic structure is non-aromatic. Non-limiting examples of this embodiment include the following:

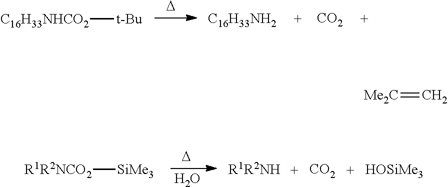

It is possible to utilize mixtures of the various latent curatives described hereinabove.

### Amount of Latent Curative

Given that crosslinking involves nucleophilic displacement of halogen from the halogenated elastomer, the amount of latent curative used relative to the amount of halogen affects the extent of polymer crosslinking. Typically, the molar ratio of latent curative to halogen is from about 0.1:1 to about 3.0:1. More preferably, the molar ratio of latent curative to halogen is from about 0.4:1 to about 1.5:1.

### Other Additives

Moisture (water) can be added to the halogenated elastomer and latent curative mixture. Providing moisture includes adding actual water, adding a compound that includes water, adding components that liberate water through reaction, heat, etc. Moisture-generating components are compounds that either include molecules of water that are reliably liberated at specific temperatures or that react to form water at certain temperatures. Non-limiting examples of moisture-generating components include, CaSO₄.2H₂O (gypsum); MgSO₄.7H₂O, or a combination thereof. Although the released water participates in reactions, the remainder of the moisture-generating component is either non-reactive or does not inhibit reactions that lead to crosslinks between polymers. In some embodiments, the halogenated elastomers are sufficiently wet to act as both the halogenated elastomer and the moisture-generating component since some halogenated elastomers include water when they are received from the manufacturer.

Provision of a hydrolysis catalyst promotes the conversion of a imine, amidine and guanidine to a more reactive N-nucleophile, and increases the rate of halogenated elastomer crosslinking. Hydrolysis catalyst may be selected from carboxylic acids; sulfonic acids; organometallic compounds including organic titanates; complexes and/or carboxylates of lead, cobalt, iron, nickel, zinc and tin; and any combination of the foregoing. The hydrolysis catalyst (or mixture of catalysts) may be present in a catalytic amount, from about 50 ppm to about 10,000 ppm, or from about 100 ppm to about 5000 ppm.

In some embodiments, a filler is added to the mixture of haloelatomer and latent curative to improve the physical properties of polymers. Fillers include carbon black, precipitated silica, clay, glass fibres, polymeric fibres and/or finely divided minerals. Typically, the amount of filler is between 10 wt % and 60 wt %. More preferably, filler content is between 25 and 45 wt %.

Provision of a nano-scale fillers such as exfoliated clay platelets, sub-micron particles of carbon black, and sub-micron particles of mineral fillers such as silica can improve the physical properties of polymers, in particular the impermeability and stiffness of the material. Typically, the amount of nano-scale filler is between 0.5 wt % and 30 wt %. More preferably, nano-scale filler content is between 2 and 10 wt %.

### Method of Preparing Mixture of Haloelastomer and Latent Additive

As described more thoroughly in the working examples, samples of haloelastomer and latent additive can be effectively mixed using equipment suited to mix elastomeric material. For example, as described in the working examples a Haake Rheomix 600 batch mixing bowl with temperature control, set at a suitable temperature, that provides insufficient heat to release CO₂ from the latent curative, and equipped with Banbury blades at 60 rpm can be used.

In certain embodiments described herein, additives are also added to the mixture of haloelastomers and latent curatives, such as moisture-generating component (e.g., gypsum), hydrolysis catalyst, and/or filler. Such additives can be added prior to mixing the haloelastomer and latent curative, or two of the three components can be mixed and then the third component mixed into the mixture of the first two. Mixing should continue until the mixture is thoroughly blended together.

In an embodiment of the invention, the halogenated elastomer is mixed with latent curative at a temperature below that which supports decomposition of the latent curative. Thus, cross-linking does not occur during the mixing process. The resulting mixture is formed into the desired shape, and heated to release CO₂ and the active N-nucleophile, thereby forming crosslinked polymeric product.

In an embodiment, the halogenated elastomer and latent imine, amidine or guanidine curative are mixed with a moisture-generating component. The resulting mixture is formed into the desired shape and heated to release CO₂, the active N-nucleophile, and water, thereby forming crosslinked polymeric product.

In another embodiment, the halogenated elastomer and latent curative are mixed with a moisture-generating component and a hydrolysis catalyst. The resulting mixture is formed into the desired shape and heated to release CO₂, the active N-nucleophile, and water, thereby forming crosslinked polymeric product.

In an embodiment, the halogenated elastomer and latent curative are mixed with conventional sulfur and zinc-based crosslinking reagents, the nature of which is not particularly restricted and within the prevue of someone skilled in the art. Non-limiting examples include sulfur, ZnO, sulfur+ZnO, quinoid resins, and the like. The resulting mixture is formed into the desired shape and heated. Thus CO₂ and active N-nucleophile are released, leading to crosslinking of halogenated elastomer by N-alkylation and by the action of conventional cure components, and forming crosslinked polymeric product.

### Method of Curing

In certain embodiments, the halogenated elastomer and latent curative are mixed and then stored and/or transported as a crosslinkable elastomeric mixture (i.e., uncured). In other embodiments, the halogenated elastomer and latent curative are stored separately and are mixed shortly before curing is desired. When curing is desired, the mixture of halogenated elastomer and latent curative is formed or molded into a desired shape, and subsequently is subjected to a trigger. A trigger is the application of sufficient heat to release CO₂ from the latent curative. In some embodiments, such release, which is due to decomposition of the latent curative, results in formation of CO₂(g) and a N-nucleophile. In some embodiments, N-nucleophile in the presence of moisture undergoes hydrolysis to form a more reactive N-nucleophile. N-nucleophiles react with the halogenated elastomers in a halide displacement reaction. Thus crosslinks between elastomers are formed and after a certain reaction time, the fully crosslinked or cured product is produced.

In certain embodiments of the invention, halogenated elastomer is mixed with latent curative and optionally with other additives at a mixing temperature that is too low to cause release of CO₂ from the latent curative. In this way, cross-linking does not occur during the mixing process. Thus, a stable uncured mixture is provided that can be stored at temperatures that are sufficiently low to ensure that CO₂ is not released from the latent curative. In some embodiments, the mixing temperature may be sufficiently high as to liberate water from a moisture-generating component. In other embodiments, the mixing temperature is not sufficiently high as to liberate water from the moisture-generating component. The resulting uncured mixture can be formed or molded into the desired shape, and then cured. Curing is conveniently possible by heating the mixture at a temperature sufficient to release CO₂ from the latent curative resulting in cured polymeric product.

As described in the following working examples, latent curatives were prepared and characterized by NMR spectroscopy. In studies described herein, these latent curatives were mixed with halogenated elastomers (e.g., BIIR and BIMS) and upon activation by a trigger were successful in crosslinking halogenated elastomers in the absence and presence of fillers and in the absence and presence of carbon black and silica. Accordingly, cured articles were prepared as described below. Notably, transparent thermoset products that were free of voids were produced. Such cured articles are reasonably expected to have superior qualities such as good thermo-oxidative stability, exceptional compression set resistance, high modulus, and excellent gas impermeability. Accordingly, articles made from such crosslinked halogenated elastomers such as, for example, tire inner liners, gaskets, and sealants, can benefit from these qualities.

### Kits

Aspects of the present invention may be supplied as a kit. In an embodiment of this aspect, the kit includes haloelastomer and latent curative that is provided as a mixture that is stored in a single container. The single container should be such that the integrity of its contents is preserved. The user of the kit would then apply the mixture to a surface (or form a desired shape) and heat. As described above, in some embodiments, the mixture further comprises water. In some embodiments, adding water can include allowing a humid atmosphere to be in contact with the mixture.

In another embodiment of this aspect, the kit includes haloelastomer and latent curative that are stored in two separate containers. One of the two containers stores haloelastomer and the second container stores latent curative. Optionally, the haloelastonner can include water (e.g., wet haloelastomer). A user would add a mixture of the two components, form a desired shape (or apply to a surface) and heat.

In another embodiment of this aspect, the kit includes haloelastomer, latent curative, and moisture-generating component. The mixture may be conveniently provided in a single container or alternatively, the kit components may be provided in a suitable number of separate containers.

For example, suitable containers include simple bottles that may be fabricated from glass, organic polymers such as polycarbonate, polystyrene, etc., ceramic, metal or any other material typically employed to hold reagents or food that may include foil-lined interiors, such as aluminum foil or an alloy. Other containers include vials, flasks, and syringes. The containers may have two compartments that are separated by a readily removable membrane that upon removal permits the components to mix. Removable membranes may be glass, plastic, rubber, or the like.

Optionally, kits may also include a molded container to house the mixture during the heating and curing process. Such molds may facilitate preparation of cured polymer in convenient or custom shapes.

Kits may also include instruction materials. Instructions may be printed on paper or other substrates, and/or may be supplied as an electronic-readable medium, such as a floppy disc, CD-ROM, DVD-ROM, Zip disc, videotape, audio tape, etc. Detailed instructions may not be physically associated with the kit; instead, a user may be directed to an Internet web site specified by the manufacturer or distributor of the kit, or supplied as electronic mail.

The following examples further illustrate the present invention and are not intended to be limiting in any respect.

### WORKING EXAMPLES

### Materials and Methods

Ammonium carbonate (30% ammonia), ammonium bicarbonate (99%), ammonium carbamate (99%), 1,8-diazabicyclo[5.4.0]undec-7-ene (“DBU”, 98%), 1-hexadecylamine (technical grade, 90%), di-tert-butyl dicarbonate (99%), and calcium sulfate dihydrate (gypsum, 98%) were used as received from Sigma Aldrich (Oakville, Ontario, Canada). Diethyl ether (anhydrous), methylene chloride, acetonitrile (HPLC grade), and magnesium sulphate (anhydrous) were used as received from Fisher Scientific (Ottawa, Ontario, Canada. Hexanes (obtained from Caledon Laboratory Chemicals of Georgetown, Ontario, Canada) were dried with Molecular Sieves Type 3A from BDH Inc. of Toronto, Ontario, Canada. CO₂ (Bone Dry Grade 2.8, 99.8%) and nitrogen were used as received from BOC (Kingston, Ontario, Canada). BIIR (LANXESS Bromobutyl 2030, allylic bromide content=0.2 mmol-g⁻¹) was used as manufactured by LANXESS Inc. (Sarnia, Ontario, Canada). BIMS (benzylic bromide content=0.21 mmol·g⁻¹) was used as manufactured by Exxon Mobil (Houston, Tex., USA).

The extent of crosslinking as a function of time was monitored through measurements of dynamic shear modulus (G′) using an Advanced Polymer Analyzer 2000 (Alpha Technologies, Akron, Ohio, USA) operating at an oscillation frequency of 1 Hz and an arc of 3°, and standard operating pressure.

### Example 1

### BIIR+(NH₄)₂CO₃ Cure Dynamics

This example illustrates the BIIR cure dynamics generated by the alkylation of ammonia released by decomposition of ammonium carbonate. BIIR (40 g) and the desired quantity of (NH₄)₂CO₃ were mixed within a Haake Polylab R600 batch mixing device (Thermo Scientific, Waltham, Mass., USA) at 50° C., 60 rpm for 5 min.

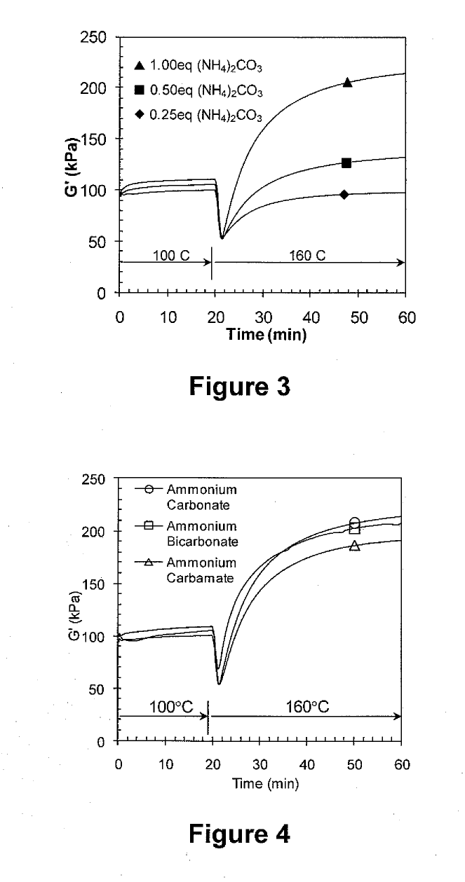

The rheometry data presented in FIG. 3 shows that, irrespective of the number of molar equivalents of (NH₄)₂CO₃ relative to the allylic bromide functionality within BIIR, the storage modulus evolved very slowly over a 20 min period at 100° C. Curing was rapid when these samples were heated to 160° C., giving transparent thermoset products that were free of voids/bubbles. That CO₂ evolution has no effect on product appearance is due to the relatively small amount of salt needed to cross-link the elastomer, and the high pressure imposed during the compression-molded curing process.

### Example 2

### BIIR Curing by (NH₄)₂CO₃, (NH₄)HCO₃, and (NH₄)NH₂CO₂

This example illustrates the BIIR cure dynamics generated by the alkylation of ammonia released by decomposition of ammonium carbonate, ammonium bicarbonate and ammonium carbamate. BIIR was mixed with 1.3 molar ammonia equivalents of the desired salt and cured in the rheometer as described in Example 1. Comparison of the cross-link densities established by these reagents revealed no significant differences in cure performance, each supported a delayed onset crosslinking process (see FIG. 4).

### Example 3

### BIIR+(C₁₆H₃₃NH₃)₂C₁₆H₃₃NHCO₂ Cure Dynamics

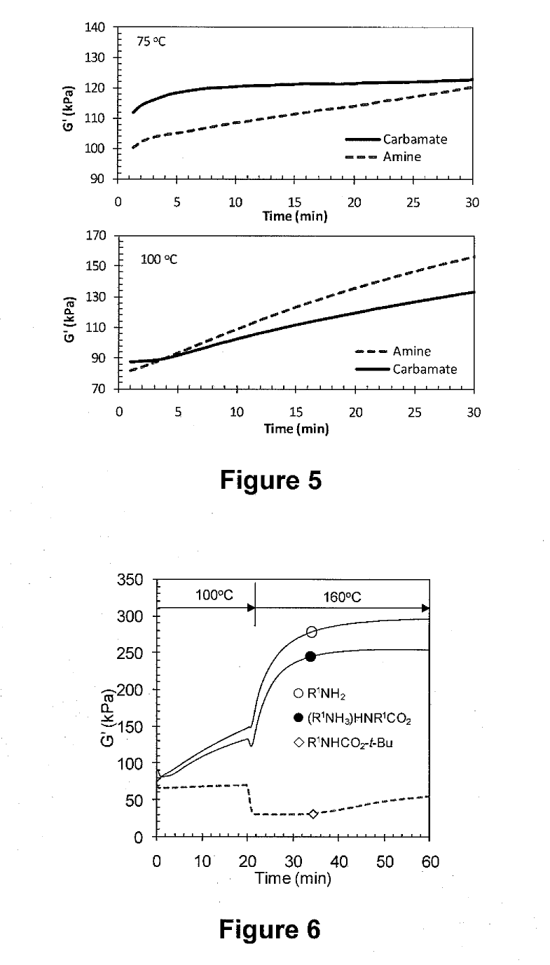

This example compares the BIIR cure dynamics of the direct alkylation of hexadecylamine to alkylation of hexadecylamine that was a decomposition product of its corresponding carbamate salt, (C₁₆H₃₃NH₃)₂C₁₆H₃₃NHCO₂. BIIR was mixed with 1.3 molar amine equivalents of C₁₆H₃₃NH₂ and cured in the rheometer as described in Example 1. The data illustrated in FIG. 5 shows evidence of slow crosslinking by the amine at 75° C., and more rapid crosslinking at 100° C. The same concentration of the corresponding carbamate salt did not crosslink BIIR at 75° C., but cured the halogenated elastomer at 100° C. (see FIG. 5).

### Example 4

### BIIR+C₁₆H₃₃NH₂ vs. BIIR+C₁₆H₃₃NHCO₂-t-Bu Cure Dynamics

Preparation of carbamate ester, C₁₆H₃₃NHCO₂-t-Bu: 1-Hexadecylamine (5.25 g, 0.22 mol) was charged into a flask with 50 mL methylene chloride. Di-tentbutyl dicarbonate (5.0 g), 40 mL of a 0.6 M solution of NaHCO₃ in H₂O, and 3.85 g NaCl were added and the reaction mixture heated at reflux for 3.5 hours. The reaction mixture was then washed with 2×25 mL of diethyl ether. Combined organic extracts were dried with anhydrous magnesium sulfate and filtered. Diethyl ether was removed under reduced pressure by rotary evaporation, and the resulting white precipitate, C₁₆H₃₃NHCO₂-t-Bu, was dried in air.

This example compares the BIIR cure dynamics of the direct alkylation of hexadecylamine to alkylation of hexadecylaamine that was a decomposition product of its corresponding carbamate ester, C₁₆H₃₃NHCO₂-t-Bu. BIIR was mixed with 1.3 molar equivalents of C₁₆H₃₃NH₂ and cured in the rheometer as described in Example 1. The data illustrated in FIG. 6 shows evidence of crosslinking by the amine at 100° C., and more rapid crosslinking at 160° C. BIIR was mixed with 1.3 molar amine equivalents of C₁₆H₃₃NHCO₂-t-Bu and cured in the rheometer as described in Example 1. As shown in FIG. 6, the carbamate ester was inactive as a curative at 100° C., but produced crosslinks at 160° C.

### Example 5

### BIIR+DBU vs. BIIR+DBUH.HCO₃ Cure Dynamics

Preparation of DBUH.HCO₃: DBU (4.6 g, 0.03 mol) was charged into a flask with 6 mL of acetonitrile. CO₂ was made wet by bubbling through water prior to use. Wet CO₂ was then bubbled into the reaction flask for 30 minutes. The resulting white precipitate, DBUH.HCO₃, was filtered under vacuum and rinsed with acetonitrile (3×5 mL).

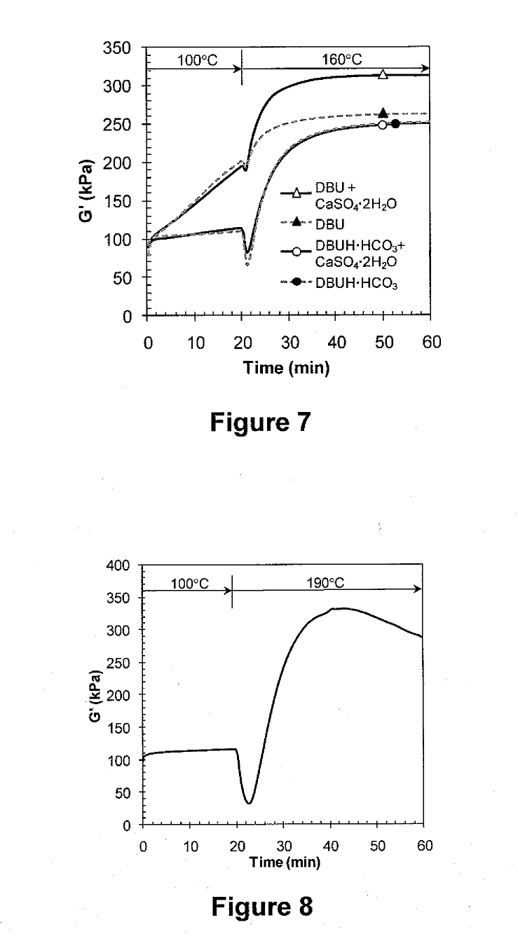

This example compares the cure dynamics generated by the direct reaction of BIIR and DBU, and the reaction of BIIR with DBU that is released by decomposition of its corresponding bicarbonate salt, DBUH.HCO₃. These cures were performed in the absence and presence of CaSO₄.2H₂O (gypsum). BIIR was mixed with 1.3 molar equivalents of DBU and cured in the rheometer as described in Example 1. FIG. 7 illustrates the evolution of the storage modulus of this formulation. This mixture crosslinked substantially when held at 100° C., and cured rapidly to a final storage modulus of 262 kPa when heated to 160° C., in spite of the fact that no moisture generating component was included in the formulation. A mixture containing BIIR+1.3 equivalents of DBU+1.3 equivalents of CaSO₄.2H₂O as a moisture generating component cured to a higher extent, giving a final storage modulus of 312 kPa. A mixture of BIIR+1.3 equivalents of DBUH.HCO₃ did not cure significantly when held at 100° C. for 20 minutes. Subsequent heating of this mixture to 160° C. resulted in rapid crosslinking to a final modulus of 252 kPa (see FIG. 7). Note that the bicarbonate salt released CO₂ and water upon decomposition. Therefore, no additional moisture generating component was used to facilitate hydrolysis. A mixture of BIIR+1.3 equivalents of DBUH.HCO₃+1.3 equivalents of CaSO₄.2H₂O cured to the same extent as the gypsum-free formulation (see FIG. 7).

### Example 6

### BIMS C₁₆H₃₃NHCO₂-t-Bu Cure Dynamics

This example illustrates the BIMS cure dynamics generated by alkylation of a primary amine that was released by decomposition of C₁₆H₃₃NHCO₂-t-Bu. BIMS was mixed with 1.3 molar equivalents of C₁₆H₃₃NHCO₂-t-Bu relative to benzylic bromide and cured in the rheometer as described in Example 1. Data illustrated in FIG. 8 demonstrates the latency of the BIMS cure at 100° C., and the high cure reactivity at 190° C.

It will be understood by those skilled in the art that this description is made with reference to certain preferred embodiments and that it is possible to make other embodiments employing the principles of the invention which fall within its spirit and scope as defined by the claims.

1. A curable elastomeric mixture comprising:
a halogenated elastomer; and
a latent curative comprising:
a CO₂ moiety; and
a N-nucleophile moiety;
wherein the mixture remains uncured until it is subjected to a trigger.

2. The curable elastomeric mixture of claim 1, wherein the trigger is sufficient heat to release CO₂ from the latent curative.

3. The curable elastomeric mixture of claim 1, wherein the latent curative comprises a CO₂-derived salt of ammonia, ammonium bicarbonate, ammonium carbamate, ammonium carbonate, a CO₂-derived salt of a primary amine, (n-C₁₆H₃₃NH₃)n-C₁₆H₃₃NHCO₂, ((MeO)₃SiCH₂CH₂CH₂NH₃)(MeO)₃SiCH₂CH₂CH₂NHCO₂, a CO₂-derived salt of an imine, a CO₂-derived salt of an amidine, a CO₂-derived salt of a guanidine, or a carbamate ester.

4.-13. (canceled)

14. The curable elastomeric mixture of claim 1, wherein the latent curative is substituted and a substituent is silane, alkoxysilane, siloxane, alcohol, epoxide, ether, carbonyl, carboxylic acid, carboxylate, aldehyde, ester, anhydride, carbonate, amine, amide, carbamate, urea, maleimide, nitrile, cyano, olefin, alkenyl, alkynyl, borane, borate, thiol, thioether, sulfate, sulfonate, sulfite, thioester, dithioester, halogen, peroxide, phosphate, phosphonate, phosphine, phosphate, alkyl, or aryl.

15.-21. (canceled)

22. The curable elastomeric mixture of claim 1, wherein halogenated elastomer comprises allylic halide functionality; benzylic halide functionality; alkyl halide functionality; or a combination thereof.

23. The curable elastomeric mixture of claim 1, further comprising a filler.

24. The curable elastomeric mixture of claim 23, wherein the filler comprises carbon black, precipitated silica, clay, glass fibre, polymeric fibre, finely divided minerals, exfoliated clay platelets, sub-micron particles of carbon black, or sub-micron particles of silica.

25. The curable elastomeric mixture of claim 1, wherein the halogenated elastomer comprises brominated butyl rubber (BIIR), chlorinated butyl rubber (CUR), brominated poly(isobutylene-co-methylstyrene) (BIMS), or polychloroprene.

26. (canceled)

27. The curable elastomeric mixture of claim 1, further comprising a moisture-generating component.

28.-30. (canceled)

31. A cured polymeric product prepared by subjecting the mixture of claim 1 to a trigger.

32. The cured polymeric product of claim 31, wherein the trigger is sufficient heat to release CO₂ from the latent curative.

33. The cured polymeric product of claim 31 or 32, wherein the latent curative comprises a CO₂-derived salt of ammonia, ammonium bicarbonate, ammonium carbamate, ammonium carbonate, a CO₂-derived salt of a primary amine, (n-C₁₆H₃₃NH₃)n-C₁₆H₃₃NHCO₂, ((MeO)₃SiCH₂CH₂CH₂NH₃)(MeO)₃SiCH₂CH₂CH₂NHCO₂, a CO₂-derived salt of an imine, a CO₂-derived salt of an amidine, bicarbonate salt of protonated DBU, or a CO₂-derived salt of a guanidine.

34.-37. (canceled)

38. The cured polymeric product of claim 31, wherein the latent curative is substituted and a substituent is silane, alkoxysilane, siloxane, alcohol, epoxide, ether, carbonyl, carboxylic acid, carboxylate, aldehyde, ester, anhydride, carbonate, amine, amide, carbamate, urea, maleimide, nitrile, cyano, olefin, alkenyl, alkynyl, borane, borate, thiol, thioether, sulfate, sulfonate, sulfite, thioester, dithioester, halogen, peroxide, phosphate, phosphonate, phosphine, phosphate, alkyl, or aryl.

39.-51. (canceled)

52. The cured polymeric product of claim 31 to 51, wherein the halogenated elastomer comprises allylic halide functionality; benzylic halide functionality; alkyl halide functionality; or a combination thereof.

53. The cured polymeric product of claim 31, further comprising a filler.

54. The cured polymeric product of claim 53, wherein the filler comprises carbon black, precipitated silica, clay, glass fibre, polymeric fibre, finely divided minerals, exfoliated clay platelets, sub-micron particles of carbon black, or sub-micron particles of silica.

55-60. (canceled)

61. A process for preparing a crosslinkable elastomeric mixture, comprising:
mixing a halogenated elastomer with a latent curative at a temperature below that which supports decomposition of the latent curative to form an elastomeric mixture that remains uncured until it is subjected to a trigger,
wherein the latent curative comprises a CO₂ moiety and a N-nucleophile moiety.

62. A process for preparing crosslinked polymer, comprising:
mixing a halogenated elastomer with a latent curative at a temperature below that which supports decomposition of the latent curative; and
subjecting the mixture to a trigger,
wherein the latent curative comprises a CO₂ moiety and a N-nucleophile moiety.

63. The process of claim 61, wherein the trigger is sufficient heat to release CO₂ from the latent curative.

64.-91. (canceled)

92. A kit comprising:
halogenated elastomer, latent curative, and instructions comprising directions to subject a mixture of the halogenated elastomer and the latent curative to sufficient heat to release CO₂ from the latent curative to form a cross-linked polymer.

93.-123. (canceled)
